(19) United States
(12) Patent Application Publication
(10) Pub. No.: US 2008/0176018 A1
(43) Pub. Date: Jul. 24, 2008

(54) Film having an electrically conductive coating

(76) Inventors: James P. Enniss, Martinsville, VA (US); Janet Yeatts, Ruffin, NC (US); Lisa Yvonne Winckler, Collinsville, VA (US)

Correspondence Address: PAUL E. MILLIKEN, 9061 WALL ST NW, MASSILLON, OH, 44646-1676, US

(21) Appl. No.: 11/656,178

(22) Filed: Jan. 20, 2007

(51) Int. Cl. B32B 33/00; B32B 5/16; B05D 3/02

(52) U.S. Cl. 428/41.8; 428/323; 428/220; 427/372.2

(57) ABSTRACT

A protective device for a glazed structure, in particular an aircraft windscreen 20, comprises at least one removable sacrificial sheet of transparent composite 10. The composite 10 comprises a transparent polymeric film 11 having on one side an electrically conductive layer 12 formed from a dispersion of electrically conductive particles and which is coated with a transparent hard coat 13, with the other side having adhesive layer 14 thereon. Sheets of the composite 10 may be arranged in a stack so that each sheet adheres to the adjacent underneath sheet with the uppermost sheet of each stack being removable as the sheet becomes damaged and/or dirty.

### FIELD

This invention relates to a transparent polymeric film composite which is suitable for the protection of glazed surfaces which are particularly susceptible to a build up of electrostatic charge.

### BACKGROUND OF THE INVENTION

It is well known to protect a vehicle windshield by the use of a protective film cover that overlies the windscreen and is adhered to the windscreen, see for example WO 99/2840. The protective cover can be easily removed by peeling from the windscreen after use. DE-A-3221-766 discloses a self adhering transparent film that is used to protect glass surface on motor vehicles and aeroplanes and which allows the glass surface to be cleaned by removal of the film.

A multilayer protective film composite for an automobile windshield is disclosed in U.S. Pat. No. 5,002,326. The different layers of film are removed successively as each film surface becomes dirty to expose a new clean film surface to improve visibility for a driver.

The transparent windshield or canopies of aircraft, in particular, helicopters are expensive and may become abraded or scratched when the aircraft is used in a harsh environment in which the air may filled with dust or sand particles such as may be found when operating is deserts.

The exposed surfaces of helicopter windscreens, in particular, accumulate large amounts of static electricity during their operation of the helicopter and this static electricity is dissipated to earth when the helicopter touches down.

It has been found that if the windshield or window of a helicopter is protected from scratches and abrasions by means of a polymeric film over layer there is an electrostatic charge build up on the outer surface of the film which discharges into the helicopter windscreen on landing and consequently burns holes in the protective over layer. Similar problems may arise when the helicopter rotors are running whilst the aircraft is sitting on the ground.

EP1154000 describes a polymeric film having a conductive thin film for static electricity prevention. The thin film comprises a layer of a resinous binder containing metal oxide particles and has a superior transparency with a total light permeability of at least 80% and a haze value of no greater than 5%. The conductive thin film is applied to glass cases, CRT screens, and as an antistatic material to clean room floor and walls.

The present invention provides a film composite which can be used as an overlay to protect aircraft windscreen from abrasions and scratches and which also prevents a build up of static electricity especially in dry and desert conditions.

### STATEMENTS OF THE INVENTION

According to one aspect of the present invention there is provided a transparent protective polymeric film composite for laying over a surface, for example glazing, the protective composite comprising a transparent polymeric film having on one side an electrically conductive layer formed from a dispersion of electrically conductive particles, the layer being coated with a transparent hard coat, said one side in use facing away from said surface.

The conductive layer may be formed from a dispersion of electrically conductive nanoparticles comprising at least one of carbon, a metal or metal oxide. The metal nanoparticles may comprise nanoparticles of aluminium, silver, gold, platinum or metal coated nanoparticles. The metal oxide nanoparticles may comprise nanoparticles of ITO (indium tin oxide), fluorine doped tin oxide, tin oxide, titanium oxy nitride, antimony doped zinc oxide and preferably the metallic oxide is ATO (antimony tin oxide). The nanoparticle size should be of less than 0.1 microns diameter.

Alternative conductive layer may be provided by a dispersion of a electrically conductive polymer such as polythiophene e.g PEDOT-PSS (Baytron) available from Bayer.

In general, the transparent composite can be used as an overlay for aircraft windows, canopies etc. to combine the advantages of a removable protective film with static electricity prevention, without loss of window transparency.

A protective device for an aircraft window may also comprise a plurality of sheets of transparent composite according to the Invention arranged in a stack so that each sheet adheres to the adjacent underneath sheet. Such an arrangement is described in EP 1489 147. The hard coat may contain a siliconized acrylate resin to assist in removal of the adjacent upper sheet.

The polymeric film may comprise one of polycarbonate, acrylic, polypropylene and PET, the preferred film being PET. The film is preferably a PET (polyethylene terephthalate) film, preferably having a thickness of between 4 mil to 7 mil (0.1 to 0.175 mm) and which m-lay contain a UV absorbing material as is disclosed in U.S. Pat. No. 6,221,112.

The composite preferably has a surface resistivity of less than 1×10⁹ ohms/square at 100 volts and when applied to glass the film composite/glass combination has optical properties such that it has a % VLT of at least 75%, preferably greater than 80%, a Haze value of less than 5%.

The conductive nanoparticles may be dispersed in a layer on one side of the film with the hard coat being coated onto said layer. Preferably, the conductive layer comprises ATO dispersed on the surface of the film with a maximum areal density of 1.0 gms per m² and preferably between 0.16-1.0 gms per m². Such a layer has a surface resistivity of 3.3×10⁷ ohms/square at 10 volts.

The conductivity of the composite is influenced by the thickness of the conductive layer, however the thicker the ATO layer then the lower the adhesion of the hard coat to the polymeric film. An increase in thickness of the conductive layer also affects the optical properties of the film composite.

In the preferred embodiment the hard coat is a UV curable acrylate based resin as is described in U.S. Pat. No. 4,557,980 the contents of which are hereby incorporated into the present specification. The hard coat after curing and drying has a thickness of about 1.8 microns and a pencil harness of about 2 H. The composite will have a surface resistivity of about 1.9×10⁸ ohms/square at 100 volts.

The other side of the PET film is coated in a suitable adhesive for adhering the composite to the glazing, and is preferably a pressure sensitive adhesive such as the solvent based adhesives including National Starch 80-1057. Suitable releasable clean peel adhesives may also be used, for example Gelva GMS 3149 (available from Cytec Inc. Surface Specialities), which in use adhere to the film layer.

A release liner may be laminated over the adhesive coating.

Glazing includes any suitable transparent material which may be used for vehicle windscreens, aircraft canopies and windscreen and windows etc. and which include glass, acrylic sheet, polyester sheet, polycarbonate sheet.

Such a composite provides a sacrificial layer which protects a windscreen from damage due to abrasion by dirt etc. and which dissipates static electricity, and has good optical properties in the visible and near infra-red. Good IR transmission allows for the use of night vision goggles or other night vision instruments through a protected screen.

Another aspect of the invention provides an aircraft window protector comprising at least one sheet of transparent composite itself comprising a transparent polymeric film having on one side an electrically conductive layer coated with a transparent hard coat, said one side in use facing away from said surface, the film having on its other side an adhesive for adherence to the window.

The protector may comprise a plurality of sheets of transparent composite comprising a transparent polymeric film having on one side an electrically conductive layer coated with a transparent hard coat containing a surface energy reducer, said one side in use facing away from said surface, the film having on its other side an adhesive, the sheets being arranged in a stack so that each sheet adheres to the adjacent underneath sheet with the uppermost sheet of each stack being removable.

Yet another aspect of the Invention provides a method of protecting an aircraft windscreen or canopy from damage due to abrasion by dirt etc. wherein in said method the windscreen is provided with a removable sacrificial layer comprising a transparent polymeric film composite which protects a windscreen, has good optical properties has optical properties in the visible such that it has a % VLT of at least 80%, a Haze value of less than 5%, and is sufficiently transmissive in the visible/near infra-red wavelengths (600-1000 nm) to allow unimpaired use of night vision goggles, and dissipates static electricity.

Also according to yet another aspect of the present invention, there is provided a method of manufacture of an anti-static protective transparent film composite in which method an aqueous dispersion of an electrically conductive material is mixed with a suitable liquid and applied to a surface a transparent film, the dispersion is dried, and then coated with a scratch resistant coating.

The dispersion preferably comprises a nanoparticle dispersion, preferably of metal or metal oxide, mixed with an organic solvent.

The metal oxide is preferably ATO and the aqueous dispersion is mixed with water miscible solvents such as methanol, isopropanol, and pyrol, to form a liquid composition having a lower surface tension and increased viscosity, thereby improving the quality of the coating and eliminating “dewets”.

### DESCRIPTION OF THE DRAWINGS

The invention will be described by way of example and with reference to the accompanying drawings in which:

FIG.1 is a cross-section through a first protective film composite according to the present invention,

FIG. 2 is a cross-section through the composite of FIG. 1 shown in situ on glazing, and

FIG. 3 is a cross-section through a second composite according to the present invention.

FIG.4 is a graph of static charge retention versus time for a windscreen and windscreen covered with prior art protective film, and

FIG. 5 is a graph of static charge retention for a windscreen and for windscreen covered with film according to the present invention.

### DETAILED DESCRIPTION OF THE INVENTION

With reference to FIG. 1 there is shown a protective film composite 10 comprising a suitable transparent polymeric film 11 coated on one side with an electrically conductive layer 12, preferably of a conductive metal oxide, which in turn is over coated with a scratch resistant hardcoat 13. The other side of the polymeric film is coated with a transparent adhesive layer 14 covered with a protective release liner 15.

Suitable transparent films 11 are polycarbonate film, acrylic film and polyester film, preferably a polyethyleneterephthalate (PET) film treated with a UV absorber as described in U.S. Pat. No. 6,221,112B so as to absorb up to 99% of UV radiation. A suitable PET film is DuPont Teijin Films' Melinex 454. The film has a thickness of about 7 mil (175 microns).

The electrically conductive layer 12 is formed from nanoparticles of ATO (antimony doped tin oxide). A 22% aqueous dispersion of ATO (available from LWB Einhoven BV, Netherlands) is modified by the addition of water miscible solvents for example, methanol, isopropyl alcohol, and pyrol. The resulting liquid composition has a lower surface tension coupled with a higher viscosity allowing the mixture to be coated into the PET film 11 using known coating techniques, for example, roller coating, reverse and forward gravure techniques, and slot die coating. In the present example the coating was applied by reverse gravure techniques.

The composition typically comprises (% by weight)

| | | |
|---|---|---|
| 100 | parts of | 22% ATO aqueous dispersion |
| 8.9 | parts | N-methyl pyrrolidone |
| 22.3 | parts | methanol |
| 13.2 | parts | isopropyl alcohol |

The coating was dried at 140° F. (60° C.) and has an areal density of ATO of between 0.16-1.00 gsm. The surface resistivity was measured at 3.3×10⁷ Ohms/square at 10 volts using a Keithley Model 6517A High Resistance Meter connected to a Model 8009 Resistivity Fixture.

Although the conductivity of the ATO layer may be increased by increasing the thickness of the layer 12 if the areal density of ATO is greater than 1.00 gsm the adhesion of the hard coat 13 becomes unacceptably low and the optical properties of the composite 10 are adversely affected.

In order to provide for a good dissipation of static electricity coupled with good optical properties, that is a % VLT (Visible light transmission) of better than 80% with a % haze <2, and high transmission in range 600-1000 nm, the areal density of ATO should be between 0.16-1.00 g/m².

The hard coat 13 is a UV cured acrylate based resin which is formed from a liquid composition which is applied over the dried ATO dispersion by any suitable process. The coating composition may comprise a resin and solvent base as is described in U.S. Pat. No. 4,557,980. The coating composition used for the hard coat layer 13 is formed from a liquid composition which is applied to the surface of the PET film by a reverse gravure process. The coating composition may comprise a resin and solvent base as is described in U.S. Pat. No. 4,557,980 and typically comprise the constituents of Table 1 below.

TABLE 1

| | |
|---|---|
| Acrylate resin | 30–75% |
| Acrylic Acid | 0–45% |
| Solvent | 0–40% |
| Photoinitiator | 2.4–5.0% |

The percentages are weight percentages of the coating mixture.

The acrylate resin is preferably a mixture of pentaerythritol tetraacrylate and triacrylate. A suitable material is Sartomer SR-295 available from Sartomer (Total). Suitable solvents, in addition to the acrylic acid which acts as a solvent, are isopropyl alcohol and MEK (methylethyl ketone).

The ingredients for the coating are mixed together and the stable mixture is stored for later use.

If a siliconized acrylate resin is to be added to the hardcoat, then 0.04-0.7% siliconized acrylate (Ebercryl 1360 available from UCB Chemical Corp) should be added to the hard coat composition.

The hard coat composition is applied using a reverse gravure process in a thickness of about 1-6 microns and coats evenly and levels smoothly. After application to the PET film the coating remains stable until drying, and UV curing after drying. The final cured dried hard coat has a thickness of about 2 microns, more typically between 1.5-2.5 microns.

The hard coat has the following typical physical properties:

Haze <1%,

Gloss 60 degree gloss 100 gloss units

Scratch resistant to 0000 Steel Wool

Abrasion <12% change in Tabor haze.

Pencil Hardness 2H-3H

Pencil Hardness is measures according to ASTM D3363-92a

The Gloss was measured using a Byk Gardner Glossmeter.

The haze was measured using a Hunter Laboratories Ultrascan XE and calculated according to (Diffuse Transmittance/Total Transmittance)×100 over a light range of 380-780 nm.

The scratch test is a subjective test in which the coating is rubbed with steel wool and viewed for scratching.

The abrasion test uses a Taber Abrader in accordance with ASTM D1044-93 using a CS10 wheels each loaded with 1 kg. The results are quoted in an increase in haze after 100 cycles.

The adhesive layer 14 is a solvent based pressure sensitive adhesive applied to the underside (in use) of the film 11 using slot die coating, or other suitable techniques and dried at 60° C. A suitable adhesive is National Starch 80-1057 modified with Tinuvin 328 to improve durability. As an alternative, the adhesive 14 could comprise an easy peel type adhesive for example Gelva GMS 3149 which adheres preferentially to the film.

The adhesion of the film composite to any underlying glazing must lie between particular limits. The adhesion must be sufficient to prevent easy release of the film composite during use but must not be so adhesive as to damage the glazing when the composite is removed.

The release liner 15 may comprise a polyethylene coated paper, or PET film with a silicone release coating, which can be peeled from the adhesive leaving the adhesive layer on the film 11.

The application of the film composite 10 to a windscreen 20 comprises are series of steps. The windscreen is cleaned using a non-hazardous film application solution comprising at least a mixture of detergent and water. The film composite sheet is cut to size and moulded to the shape of the surface to be protected. The release liner 15 is removed from the composite 10 and both the windscreen and adhesive layer 14 are sprayed with said solution. The film is placed over the surface and smoothed into place, expelling all air pockets. The adhesive layer 14 is then allowed to cure for 24 hours.

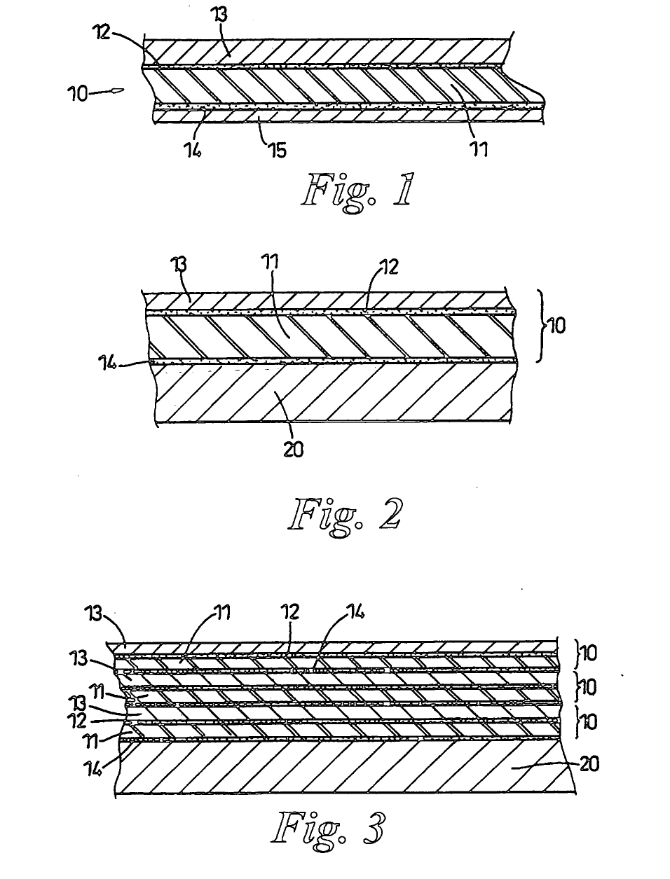

FIG. 2 shows a composite 10 in place on a windscreen shown with the release liner 15 removed and the composite 10 adhered to glazing 20 for example a helicopter windscreen.

In use, the protective film composite 10 may be cleaned using the standard windscreen cleaning techniques. The composite 10 is not harmed by standard window cleaning chemicals, for example Windex.

Film Clarity

The optical clarity of the windscreen protected by composite 10 was tested for comparison with a unprotected screen, by means of a subjective test in which an observer viewed optical charts through the screens at various distances. There was no noticeable difference between the two windscreens.

Compatibility with Night Vision Goggles

The film composite 10 was tested by means of subjective test in which pilots equipped with night vision goggles flew helicopters having half the windscreen covered in the composite film. The pilots flew for periods of 1.5 hours in various light levels from rural dark to well lit urban environments. The testing showed that the composite film 10 did not affect night vision goggle performance.

Electrostatic Testing

Electrostatic Testing was performed by applying static charge using a high voltage, low current device. The induced charge and charge decay characteristics were measured on the bare windscreen and windscreen covered with prior art none conductive protective film for a 35 kV induced charge.

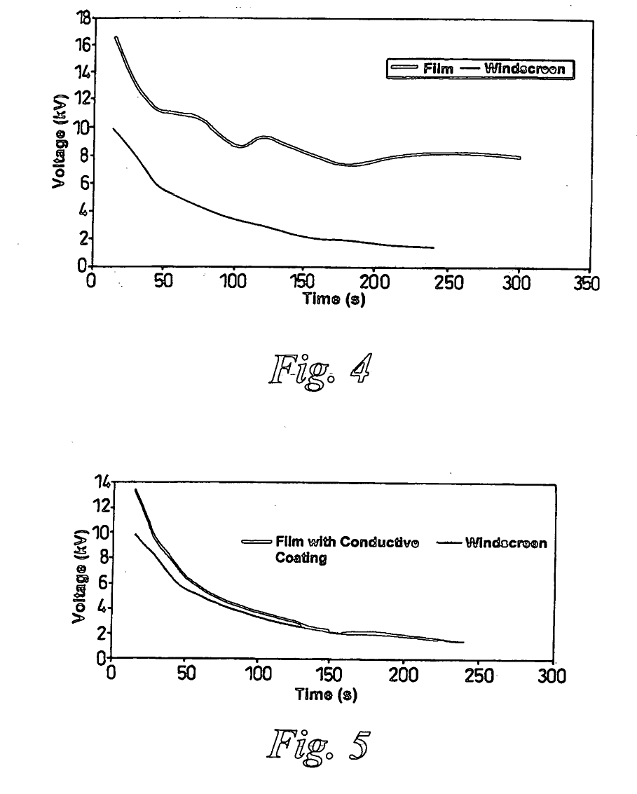

The results of the test showed that the protective film acted as a capacitor, storing up charge until a level was reached and the built-up charge would arc to the nearest conductive-material, the windscreen. The windscreen dissipated the 35 kV-induced charge in less than five minutes, whereas the very insulative protective film effectively held a charge greater than 8 kV for more than five minutes, as seen in FIG. 4. The film was also observed to hold a charge of 8 kV for up to 30 minutes. The protective film held the charge in pockets until enough was built-up, where it would then arc through the film to the windscreen. There was no visible arcing, however small burns ranging in size from a pencil tip to an eraser were evident in the protective film. There were 5 to 10 noticeable burn holes generated on each protective film after one full charging test. Analysis determined that locations of the holes were driven by underlying contaminants, acquired during installation.

Electrostatic Testing of Film with Conducting Protective Coating.

Two 8 inch×4.5 inch (200 mm×112.5 mm) samples of composite 10 according to the present invention, as well as a sample of the prior art non-conductive film were installed on an aircraft windscreen. The non-conductive control film test data obtained on the second test exactly matched the data collected during the first test. The sample of composite 10 were comparable to the plain windscreen in the manner in which the static electricity discharged, as seen in FIG. 5.

The composite 10 has a resistivity less than 1×10⁹ ohms/square, preferably about 2.0×10⁸ Ohms/square, and typically 1.9×10⁸ Ohms/square in order to dissipate static electrical charge from the windscreen and prevent damage to the composite.

Resistance to Use of Wipers

Wipers of an aircraft fitted with the protective film were operated for 1 minute on each a dry and moist windscreen while the aircraft was parked on the ground. A follow-on test evaluated the same criteria during in-flight operation of the dry wipers. The tests were also repeated under a moist windscreen/wiper condition. The results of the test showed that the composite 10 was not affected by the usage of dry or moist wipers on the ground or during flight.

Resistance to Windspeed

A speed sweep was performed on aircraft that had the protective film installed to evaluate the films ability to stay adhered to the windscreen. The tested speeds ranged from hover to 310 knots. The testing showed that the protective film was not affected by the speed of the aircraft. The film remained clear and attached under each flight speed.

Resistance to Temperature

The protective film's ability to remain clear and adhered to the windscreen was evaluated for low temperatures. The aircraft windshield's operating temperature range is from −65-160° F. (−55-70° C.).

A sample of the 7 mil protective film was attached to a piece of glass. A preliminary test was performed where the sample was cold temperature cycled numerous times from −15-70° F. (−25-21° C.) to determine if there was any shrinkage or peeling in the protective film and if any discoloration, bubbling, or hazing occurred. The test results showed no anomalies and the film adhesive strength was not affected by the cold temperature.

Through flight-testing, the protective film was evaluated in the temperature range of 35° C. to −35° C. The results of the temperature evaluation showed that the protective film was not affected by temperature. The film remained clear and attached under each evaluated temperature.

Durability

The protective film's durability and ability to protect the underlying windscreen was evaluated throughout the test program. Sand blasting testing showed that a film covered windscreen could last nearly twice as long as the glass windscreen alone before needing maintenance. The film was flight tested for more than 100 hours between the three test aircraft. The protective film has flown in harsh operating extremes, such as brown-out and hot/old temperature conditions. The film's durability was evaluated during the brown-out condition testing. Two aircraft, were submitted to brown-out conditions during landings and take-offs, where the windscreens were blasted with dust, sand, and rocks. Throughout the 7 days of testing, each aircraft logged over 50 take-offs and landings. After each test day the aircraft's windscreens were evaluated and a comparison was made between the windscreen with the protective film and the one without. Throughout the test, the windscreens began to pit and show damage. The windscreen with the protective film was protected and remained unaffected by the elements, where as the windscreen without began to become more difficult to see through due to the pitting and other damages.

Another embodiment of the Invention is shown in FIG. 3, which shows a plurality of sheet of composite 10 stacked one on the other on a windscreen 20. The hard coat layers 13 incorporate a siliconized acrylate resin to reduce the surface energy to enable upper sheets of composite to be removed from underlying sheets as the upper most sheet becomes damaged and difficult to see through.

What is claimed is:

1. A transparent protective polymeric film composite for laying over a surface, the protective composite comprising a transparent polymeric film having on one side an electrically conductive layer formed from a dispersion of electrically conductive particles, said layer being coated with a transparent hard coat, said one side in use facing away from said surface.

2. A film composite as claimed in claim 1 wherein the conductive layer is formed from a dispersion of electrically conductive nanoparticles.

3. A film composite as claimed in claim 2, wherein the conductive layer comprises nanoparticles of a metallic oxide filler.

4. A composite as claimed in claim 3 wherein the metallic oxide filler is preferably ATO (antimony tin oxide).

5. A film composite as claimed in claim 1 wherein the polymeric film may comprise one of polycarbonate, acrylic, polypropylene and PET.

6. A film composite as claimed in claim 5 wherein the film is preferably a PET (polyethylene terephthalate) film about 7 mil (0.175 microns) thick and containing a UV absorbing material.

7. A Composite as claimed in claim 1 having a surface resistivity of less than 1×10⁹ ohms/square at 100 volts and when applied to glass.

8. A composite as claimed in claim 4, wherein said layer comprises ATO particles dispersed onto the surface of the film with a maximum areal density of 1.00 g/m².

9. A composite as claimed in claim 8, wherein the areal density of ATO nanoparticles is between 0.16-1.00 gm per m² and the film and deposited layer has a resistivity of about 3.3×10⁷ ohms/square at 10 volts.

10. A composite as claimed in claim 1, wherein the hard coat is a UV curable acrylate resin having a thickness of about 1.8 microns and a pencil hardness of between 2 H and 3 H.

11. A composite as claimed in claim 1, wherein the other side of the film is coated in an adhesive for adhering the composite to glazing.

12. A composite as claimed in claim 11, wherein a release liner is laminated over the adhesive coating.

13. A glazed structure having glazing with an overlayer of film composite adhered thereto, said composite being a composite in accordance with claim 12.

14. A transparent protective polymeric film composite for laying over a surface, the protective composite comprising a transparent polymeric film having on one side a transparent electrically conductive layer formed from a dispersion of nanoparticles of ATO, said one side in use facing away from said surface, with a hard coat being coated onto said layer, the areal density of ATO nanoparticles being between 0.16-1.00 gm per m² and the hard coat is a UV curable acrylate resin having a thickness of about 1.8 microns and the composite has a surface resistivity of about 1.9×10⁸ ohms/square at 100 volts.

15. A composite as claimed in claim 14, wherein the other side of the film is coated in an adhesive for adhering the composite to glazing.

16. A composite as claimed in claim 15, with a release liner laminated over the adhesive coating.

17. A glazed structure having glazing with an overlayer of film composite adhered thereto, said composite being a composite in accordance with claim 16.

18. A glazed structure as claimed in claim 17, wherein the film composite/glass combination has optical properties such that it has a % VLT of at least 75%, preferably greater than 80%, a Haze value of less than 5%.

19. An aircraft window protector including at least one sheet of transparent composite comprising a transparent polymeric film having on one side an electrically conductive layer coated with a transparent hard coat, said one side in use facing away from said surface, the film having on its other side an adhesive for adherence to the window.

20. An aircraft window protector including a plurality of sheets of transparent composite comprising a transparent polymeric film having on one side an electrically conductive layer coated with a transparent hard coat containing a surface energy reducer, said one side in use facing away from said surface, the film having on its other side an adhesive, the sheets being arranged in a stack so that each sheet adheres to the adjacent underneath sheet with the uppermost sheet of each stack being removable.

21. A protective device as claimed in claim 20 wherein the hard coat contains a siliconized acrylate resin to assist removal of the adjacent upper sheet.

22. A method of protecting an aircraft windscreen or canopy from damage due to abrasion by dirt etc. wherein in said method the windscreen is provided with a removable sacrificial layer comprising a transparent polymeric film composite which protects a windscreen, has good optical properties has optical properties in the visible such that it has a % VLT of at least 80%, a Haze value of less than 5%, and is sufficiently transmissive between the wavelengths 600-1000 nm to allow unimpaired use of night vision goggles, and dissipates static electricity.

23. A method of manufacture of an anti-static protective transparent film composite in which method, an aqueous dispersion of nanoparticles of conductive material are applied to a surface a transparent film, the dispersion is dried, and then coated with a scratch resistant coating.

24. A method as claimed in claim 23, wherein conductive material is a metal oxide and the aqueous dispersion is mixed with water miscible solvents selected from methanol, isopropanol, and pyrol, to form a liquid composition.
